(19) United States
(12) Patent Application Publication
(10) Pub. No.: US 2002/0145330 A1
(43) Pub. Date: Oct. 10, 2002

(54) LED lighting ring on motorcycle wheel

(76) Inventors: David C. Abbe, El Cajon, CA (US); Thomas H. Rudd, Hudson, WI (US)

Correspondence Address: WESTMAN, CHAMPLIN & KELLY, A PROFESSIONAL ASSOCIATION, SUITE 1600 - INTERNATIONAL CENTRE, 900 SECOND AVENUE SOUTH, MINNEAPOLIS, MN, 55402-3319, US

(21) Appl. No.: 09/816,759

(22) Filed: Mar. 23, 2001

(51) Int. Cl. B60B 7/00

(52) U.S. Cl. 301/37.108

(57) ABSTRACT

A light carrying ring or ring segment is mounted onto a cover used over the rotor of a disc brake on a front wheel of a motorcycle. The ring has a plurality of windows or apertures there through, and has a flange adjacent the wheel. The flange carries a flexible circuit board with a pair of LEDs adjacent each of the windows, such that the LEDs closest to the windows can be a street legal color, and the LEDs spaced from the windows can be a variant color for reflecting light off the wheel of the motorcycle.

### BACKGROUND OF THE INVENTION

The present invention relates to an apertured, light carrying ring for mounting a support adjacent a wheel, such as a disc brake rotor cover, which is fixed on a front fork or frame of a motorcycle to provide a ring of LED lights visible from the exterior. The ring also has lights which reflect on the wheel and/or a brake disc.

Trim lighting for motorcycles has been desired for accent, and visibility. A ring of incandescent bulbs has been utilized for decorative lighting on motorcycles, including such bulbs on apertured rings which are supported on brake rotor covers. These use a single row of incandescent lights that are relatively large, and only one color by each aperture.

The present invention utilizes a flexible circuit board carrying LEDs that can be mounted on the interior of a peripheral flange on the ring, and which provide the ability to make a wide variety of lighting combinations simply and quickly.

### SUMMARY OF THE INVENTION

The present invention relates to an apertured ring that mounts onto a frame portion or non-movable portion of a motorcycle, such as a brake rotor cover that covers a disc brake on the front wheel of a motorcycle. The ring has a plurality of apertures around the periphery. A flexible circuit board is mounted on an inner side of a peripheral rim of the ring, and the circuit board carries a pair of LEDs aligned with each of the apertures or openings. One LED is to the exterior of the other.

The LEDs which are on the side toward the exterior of the wheel are maintained at a legal color, such as amber, while the LEDs to the interior, which direct light toward portions of the wheel or the brake disc, and which then cause reflection of this light in a changing pattern, can be selected LED colors such as blue, amber, red or green. The flexible circuit boards are made so that they fit around the annular flange formed by the perforated ring, and draw little current, and are easily connected to the vehicle power supply. The rings can be made in part annular sections so that they can be bolted in place on the outer periphery of a rotor cover, which is the most convenient way of supporting the ring. The ring does not make a full circle, but may extend around the region of the rotor that is visible from the side.

The rings can also be supported in other ways to the frame. The rings are held stationary which makes the electrical connection simple. Various colors that can be selected to provide for a brilliantly vibrant glow around the wheel, and can be selected to match most paint schemes, so that the glow is an important aesthetic feature to motorcycle riding.

### BRIEF DESCRIPTION OF THE DRAWINGS

FIG. 1 is a perspective view of a motorcycle having a brake disc cover supporting a light ring made according to the present invention;

FIG. 2 is a fragmentary perspective view of a light ring removed from the motorcycle;

FIG. 3 is a view taken generally along line 3--3 in FIG. 1;

FIG. 4 is an exterior edge view of a ring made according to the present invention;

FIG. 5 is a sectional view taken as on line 5--5 in FIG. 4;

FIG. 6 is a fragmented side view of a modified form of the invention;

FIG. 7 is a sectional view taken as on line 7--7 in FIG. 6; and

FIG. 8 is a sectional view taken as on line 8--8 in FIG. 6.

### DETAILED DESCRIPTION OF THE PREFERRED EMBODIMENTS

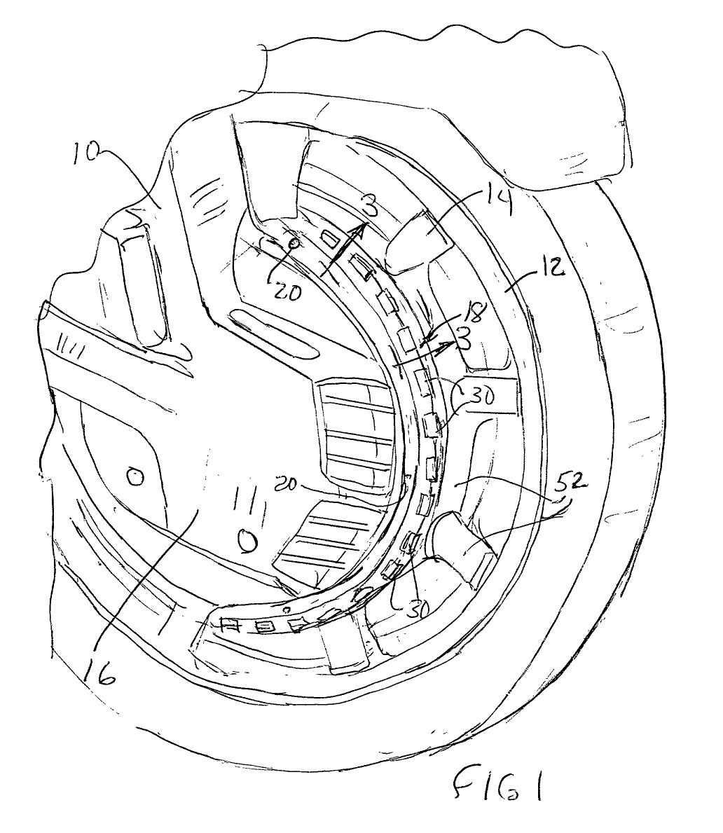

Referring to FIG. 1, a motorcycle frame 10 is shown as a front fork, that supports a wheel 12, that can have chrome spokes with highlight covers indicated at 14, as well as having a brake disc or rotor on the side of the wheel (not shown). A brake rotor cover 16 is supported on the frame 10, and as shown it is made for covering a conventional brake disc that is used for braking the front wheel 12 of the motorcycle.

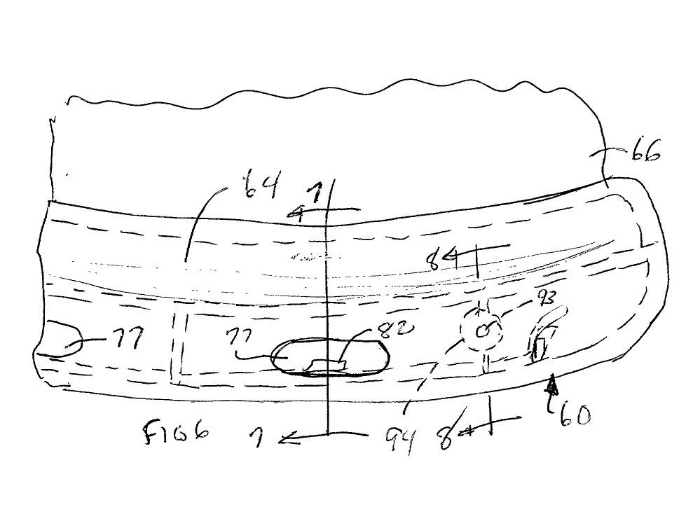

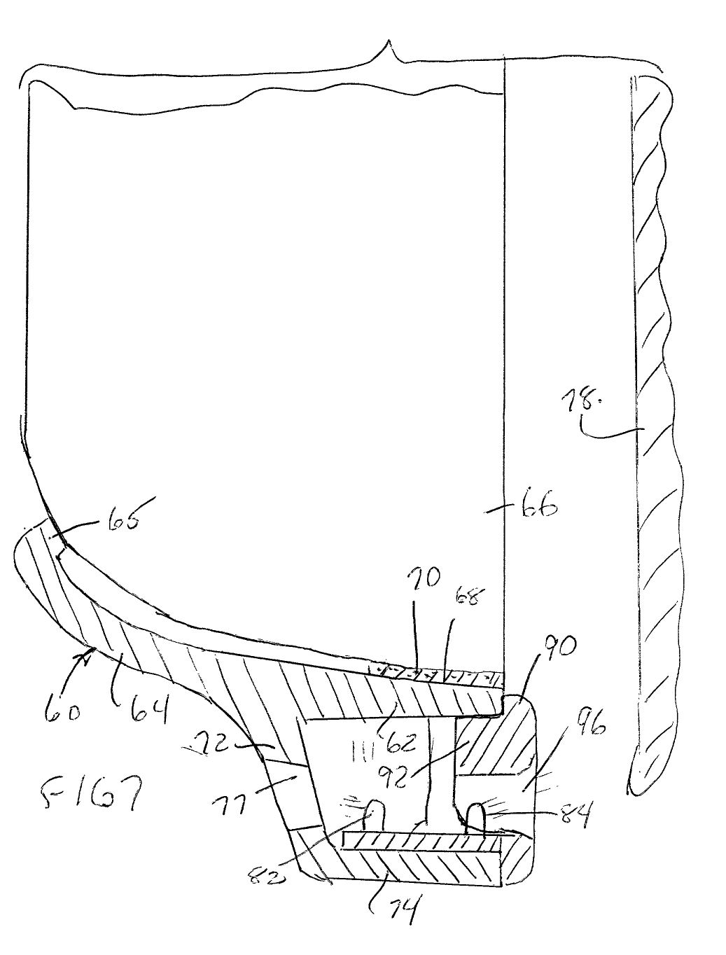

A light ring segment made according to the present invention is shown at 18, and is bolted with suitable screws or bolts 20 to the periphery of the rotor cover 16. The ring 18 is a formed ring and includes a plurality of apertures or windows 22 that are evenly spaced around the periphery, and which are formed to extend partially into a generally horizontal flange 26 (see FIG. 5) that extends inwardly toward the wheel represented only at 28. The main parts of the apertures then are formed on a sloping section 30 of the wheel ring 18. The sloping section 30 extends downwardly from the flange 26, toward the inner periphery of the ring 18, and a flange 32 is formed outwardly from the sloping section. The ring is secured to the cover 16 with screws 20 extending through flange 32.

With the openings 30 formed partially in the flange 26, and partially in the sloping section 32, it can be seen that the openings then have a portion that extends essentially radially out as indicated by the arrow 38 in FIG. 5, as well as horizontally out as indicated by the arrow 40.

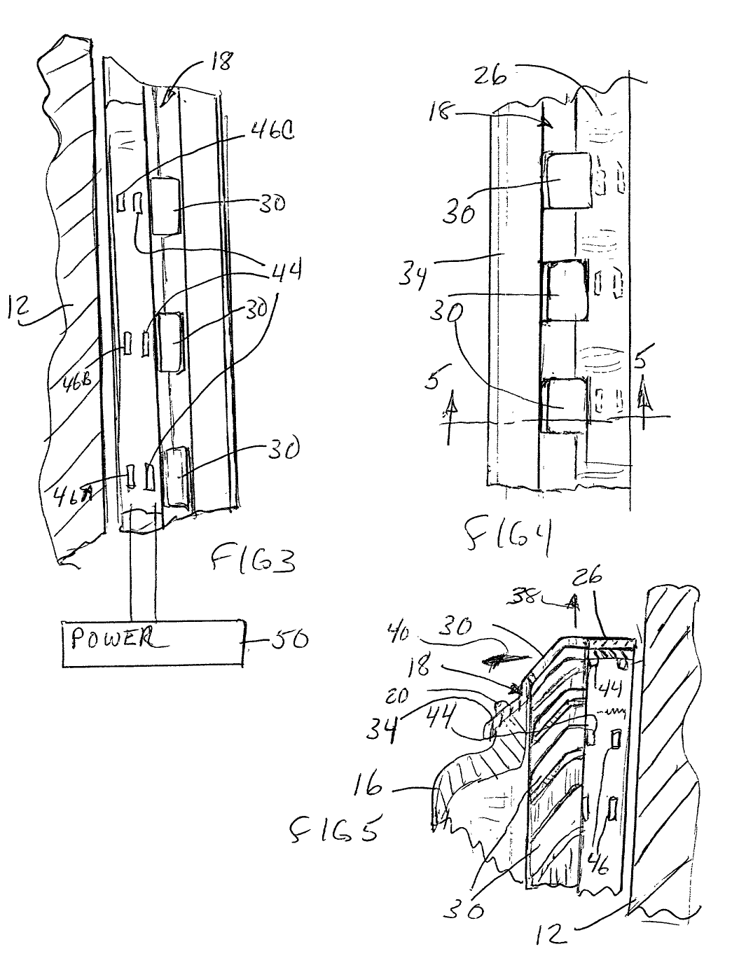

The outer or peripheral flange 26, which is a horizontal flange carries a flexible circuit board 42 on its interior surface. The flexible circuit board 42 is fastened by adhesives or other suitable compositions directly to the inner surface of the flange 26, and is formed around the periphery of the ring. The circuit board 42 is shown in an interior view in FIG. 3, and it can be seen that there are a pair of LEDs by each of the apertures 30, including an outer LED row 44, which is toward the outside of the wheel, and an inner row of LEDs 46, which also align with each of the windows 30 around the periphery of the ring.

The LEDs 44 that are adjacent the windows 30 are amber in order to comply with local ordinances, so that from the side of the motorcycle, as shown in FIG. 1, the amber LEDs would be seen. The inner row of LEDs 46 is of a selected color that can include amber, as well as blue, green, and red. The LEDs 46 can be alternated in color as well, so that the colors can be blue and green, or red and blue if desired for example.

Flexible circuit boards are made of well known materials, that can be adhesively secured to the flange 26 of the metal ring, and held in place. The circuit board includes leads that are extended outwardly, and engage a power supply 50, that would be the motorcycle battery and charging system.

The rings can be made in different sizes, and can be supported on mountings that are integral with the frame, as shown in FIG. 1, or they can be supported by after market rotor covers that are attached to the front fork of a motorcycle.

The different color combinations can be made easily, by substituting different LEDs in the circuit board.

In FIG. 3, the LEDs 46A can be, for example, red, and the LEDs 46B can be blue, the LED 46C can be green, or the different color combinations can be made with only two colors, or one single color such as having all of the LEDs 46 green, red, blue or even amber.

In FIG. 1, it can be seen that the LEDs that would be on the exterior side of the flange 26 and shining out to the side through the openings or windows 30 will be the amber LEDs, but it also can be seen that the inner ring of LEDs that is adjacent to the wheel will project light inwardly toward the wheel 12, which will reflect the light outwardly, and will provide a glow on the radial portion 52 of the wheel that extends out beyond the ring 18 as shown in FIG. 1. The LED's selected can have a wide angle of light projection, for example 120° projection LED's are available.

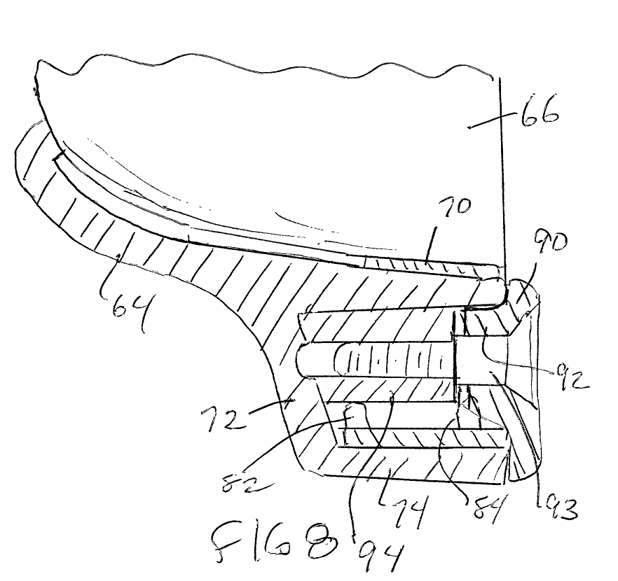

In FIGS. 7, 8 and 9, a modified form of the present invention is shown, as used on a different motorcycle. A light ring 60 is formed in segments as shown, and is a cast ring. The light ring 60 has an inner wall 62 that has an outwardly extending section 64 to form a support for a rotor cover 66 that is fixed to the front fork or frame of a motorcycle. The wall 62 has an inner portion 68 that is secured to the rotor cover 66 with an adhesive layer 70. The wall 64 has a rim 65 that rests on the rotor cover 66.

The ring 60 includes an offset radial wall 72 that extends radially outward from the drum and joins an outer flange 74 that is parallel to and spaced from the wall portion 68 to form a channel shape that defines an annular channel shaped recess or opening 76. The radial wall 72 has a plurality of elongated slots or openings 77 that face laterally out from the motorcycle wheel shown at 78.

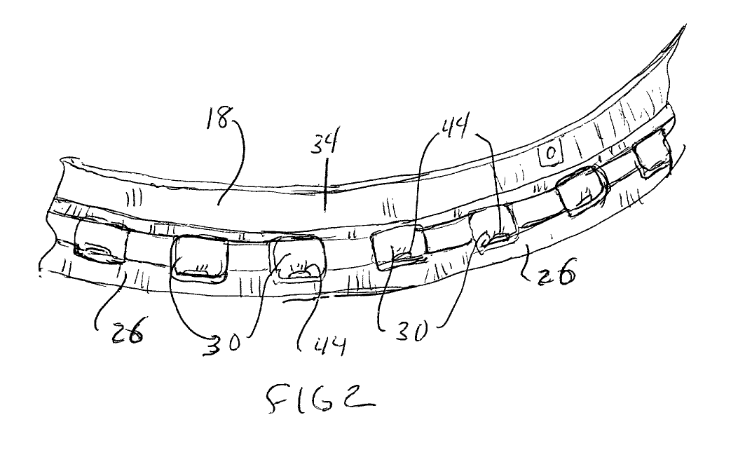

The flange 74 has an inner surface on which a flexible circuit board 80 is secured, for example with suitable adhesive or fasteners. The circuit board 80 is the same as shown in FIGS. 1-5 and has a plurality of LED's 82 in an annular row adjacent radial wall 72 and thus adjacent the openings 77.

A second annular row of LED's 84 is positioned on the open side of annular recess 76. The LED's 82 thus shine out openings 77 and LED's 84 can shine on the wheel 78 through the open side of the channel shaped recess 76. The opening formed by the open side is part annular, and it is centered on the axis of the associated wheel, as is the flange 74. The color selection for the LED's can be as previously discussed.

If desired, the LED's and the circuit board can be protected by using a cover ring 90 that has a guide block 92 that slips into the recess 76. The cover ring 90 is held in place with a number of screws 93 that thread into sleeves 94 that are cast in place. The cover ring 90 has slots or openings 96 that align with slots 77 in wall 72 and thus they also align with the LED's 84. The LED's 82 and 84 are super-bright and shine out slots or openings 96 toward the wheel 78 to give the pleasing visual effects described previously.

The light rings in both forms of the invention can have a polished chrome finish for great reflection.

The number of windows or apertures 30 or 77, and their size and spacing around the ring can be selected as desired.

The rings 18 and 60 are easily installed in segments on existing components, and if necessary holes can be drilled easily on the rotor cover or onto frame support members.

Electrical wires and connections can be made along the stationary frames, so that there is no need for commutators or slip rings for carrying electrical power.

It also can be seen that with spokes on the wheels as shown at 14, the LED light can be observed as forming radially extending reflected light.

Although the present invention has been described with reference to preferred embodiments, workers skilled in the art will recognize that changes may be made in form and detail without departing from the spirit and scope of the invention.

Although the present invention has been described with reference to preferred embodiments, workers skilled in the art will recognize that changes may be made in form and detail without departing from the spirit and scope of the invention.

What is claimed is:

1. A light ring for mounting onto a stationary portion of a vehicle frame adjacent a wheel, said ring including a radially extending portion, and a flange that extends generally parallel to an axis of rotation of the wheel, the ring having a plurality of windows that are spaced around the a periphery of the ring, the windows being to an exterior side of the flange, and a plurality of LEDs mounted on the flange, with at least two LEDs adjacent each window, one adjacent the window and one adjacent a wheel, said LEDs having a selected light color.

2. The ring of claim 1, wherein the LEDs adjacent the wheel are a different color from at least some of the LEDs adjacent the windows.

3. The ring of claim 2, wherein said windows have a portion that is formed in the flange, and a portion that is formed in the radially extending portion of the ring.

4. The ring of claim 2, and a portion of the ring includes means for attaching the ring to a rotor cover for a brake disc on the wheel of the vehicle.

5. The ring of claim 1, wherein said vehicle is a motorcycle.

6. The ring of claim 1, wherein said LEDs are secured to a flexible circuit board, the circuit board extending along the flange on an interior surface thereof and being adhered to the interior.

7. The ring of claim 6, wherein the radially extending portion includes a wall portion attached to the flange that inclines outwardly from the flange in a radial direction toward a center of the ring.

8. The ring of claim 7, wherein a substantial portion of the windows are formed in the wall portion.

9. A light ring segment for mounting onto a stationary portion of a motorcycle frame adjacent a wheel, said ring segment being formed part annularly around an axis and including an inner edge, a wall portion extending outwardly from the inner edge, and a flange joined to an outer edge of the wall portion, the flange extending generally parallel to the axis, the ring having a plurality of windows that are spaced apart around the part annular ring segment, the windows being formed in the wall portion and facing outwardly from the ring, and a plurality of LEDs mounted on an interior surface of the flange, with at least two LEDs aligned with each window, one adjacent the window and one spaced from the window, said LEDs having a selected light color.

10. The light ring segment of claim 9, wherein the LEDs are mounted on a flexible circuit board, the flexible circuit board being adhesively secured to an inner surface of the flange.

11. The light ring of claim 9 wherein a second wall parallel to the flange is spaced inwardly from the flange to form a channel shaped opening facing toward the wheel of the motorcycle.

12. The light ring of claim 11 and a cover over the channel shaped opening, the cover having inner window openings aligning with the LED's spaced from the windows formed in the wall portion.

13. The light ring of claim 11 wherein the channel shaped opening is part annular and is centered on the wheel axis.

14. The light ring of claim 11 wherein the light ring is a cast molded ring.
